(19) United States
(12) Patent Application Publication
(10) Pub. No.: US 2014/0185083 A1
(43) Pub. Date: Jul. 3, 2014

(54) NETWORK PRINTER SELECTION BASED ON PRINTER STATUS AND PROFILES

(71) Applicant: INTERNATIONAL BUSINESS MACHINES CORPORATION, Armonk, NY (US)

(72) Inventors: Gary D. Cudak, Creedmoor, NC (US); Chistopher J. Hardee, Raleigh, NC (US); Randall C. Humes, Raleigh, NC (US); Adam Roberts, Moncure, NC (US)

(73) Assignee: INTERNATIONAL BUSINESS MACHINES CORPORATION, Armonk, NY (US)

(21) Appl. No.: 13/729,383

(22) Filed: Dec. 28, 2012

(51) Int. Cl. G06F 3/12

(52) U.S. Cl. CPC G06F 3/1296
USPC 358/1.15

(57) ABSTRACT

A computer program product maintains a printer profile associated with each of a plurality of printers. For each printer, the printer profile includes the current power status, a cost to power up, and a rate of cost to print. A print job is received and, for each printer, a total cost to print the print job, including the cost to power on the printer, is determined. The print job is redirected from a default printer to a destination printer selected from printers having a lower total cost to print. Each printer profile may further include a time period to power up and a print speed, and, for each printer, a total time period to print the print job is determined. The total time period includes an amount of time to complete other print jobs, and further includes, where the printer is off, the time period to power on the printer.

### BACKGROUND

1. Field of the Invention

The present invention relates to print manager applications.

2. Background of the Related Art

Businesses of any significant size will typically have a computer network that includes many individual computers and a plurality of network printers. The types of printers available on the network will vary and each printer will have its own characteristics. Furthermore, the location of a printer may play an important role in an individual user selecting that printer as its default printer.

However, during period when the demand for print resources is low, such as evenings or weekends, it may be advantageous to power off many of the network printers. Accordingly, print jobs submitted for printing during these periods may be concentrated on a reduced number of printers.

### BRIEF SUMMARY

One embodiment of the present invention provides a computer program product including computer usable program code embodied on a tangible computer usable storage medium for handling a print job. The computer program product includes computer usable program code for maintaining a printer profile associated with each of a plurality of printers, wherein each printer profile includes the current power status of the associated printer, a cost to power up the associated printer, and a rate of cost to print. The computer program product further includes computer usable program code for receiving a print job having a job size, and computer usable program code for determining, for each of the plurality of printers, a total cost to print the print job, wherein the total cost to print the print job includes the mathematical product of the rate of cost to print and the job size, and wherein, in response to the printer status indicating that the printer is powered off, the total cost further includes the cost to power on the printer. Still further, the computer program product includes computer usable program code for redirecting the print job from a default printer to a destination printer selected from the plurality of printers having a lower total cost to print.

Another embodiment of the invention provides another computer program product including computer usable program code embodied on a tangible computer usable storage medium. The computer program product comprises computer usable program code for maintaining a printer profile associated with each of a plurality of printers, wherein each printer profile includes the current power status of the associated printer, a time period to power up the associated printer, and a print speed. The computer program product further includes computer usable program code for receiving a print job having a job size, and computer usable program code for determining, for each of the plurality of printers, a total time period to print the print job, wherein the total time period to print the print job includes the quotient of the job size divided by the print speed, wherein the total time period to print the print job further includes an amount of time necessary to complete any other print jobs ahead of the print job in a print queue for the printer, and wherein, in response to the printer status indicating that the printer is powered off, the total time period to print the print job further includes the time period to power on the printer. Still further, the computer program product includes computer usable program code for redirecting the print job from a default printer to a destination printer selected from the plurality of printers having a lower total time period to print the print job.

### BRIEF DESCRIPTION OF THE SEVERAL VIEWS OF THE DRAWINGS

FIG. 1 is a diagram of a server running a print manager application for handling a print job in accordance with one embodiment of the present invention.

FIG. 2 is a diagram of a computer capable of running a print manager application in accordance with various embodiments of the present invention.

FIG. 3 is a flowchart of a method of handling print jobs based upon the total cost to print the print job.

FIG. 4 is a flowchart of a method of handling print jobs based upon the total time period to print the print job.

### DETAILED DESCRIPTION

One embodiment of the present invention provides a computer program product including computer usable program code embodied on a tangible computer usable storage medium for handling a print job. The computer program product includes computer usable program code for maintaining a printer profile associated with each of a plurality of printers, wherein each printer profile includes the current power status of the associated printer, a cost to power up the associated printer, and a rate of cost to print. The computer program product further includes computer usable program code for receiving a print job having a job size, and computer usable program code for determining, for each of the plurality of printers, a total cost to print the print job, wherein the total cost to print the print job includes the mathematical product of the rate of cost to print and the job size, and wherein, in response to the printer status indicating that the printer is powered off, the total cost further includes the cost to power on the printer. Still further, the computer program product includes computer usable program code for redirecting the print job from a default printer to a destination printer selected from the plurality of printers having a lower total cost to print.

In a further embodiment, the computer usable program code for redirecting the print job from a default printer to a destination printer selected from the plurality of printers having a lower total cost to print, includes: computer usable program code for automatically selecting the destination printer; and computer usable program code for automatically redirecting the print job from the default printer to the destination printer. User settings or administrative tools may be used to establish that the destination printer should be automatically selected, as well as establish the criteria for automatically selecting the destination printer. For example, the criteria might prioritize printers that are physically closest to the default printer or provide the lowest total cost to print.

In a still further embodiment, the cost may be expressed in an amount of power or currency. For example, power may be provided in units of Watts (joule per second), and currency may be provided in dollars ($). In a specific, non-limiting example, the rate of cost to print is an amount of cost per page (such as Watts/page), and wherein the job size includes a total number of pages.

In an additional embodiment, the computer usable program code for redirecting the print job from a default printer to a destination printer selected from the plurality of printers having a lower total cost to print, includes: computer usable program code for displaying one or more of the plurality of printers having a lower total cost to print; and computer usable program code for receiving a user selection of the destination printer from the one or more displayed printers. This embodiment provides the user with a greater amount of context over the printer selection, but leaves the selection to the user.

An alternative embodiment of the invention provides another computer program product including computer usable program code embodied on a tangible computer usable storage medium. The computer program product comprises computer usable program code for maintaining a printer profile associated with each of a plurality of printers, wherein each printer profile includes the current power status of the associated printer, a time period to power up the associated printer, and a print speed. The computer program product further includes computer usable program code for receiving a print job having a job size, and computer usable program code for determining, for each of the plurality of printers, a total time period to print the print job, wherein the total time period to print the print job includes the quotient of the job size divided by the print speed, wherein the total time period to print the print job further includes an amount of time necessary to complete any other print jobs ahead of the print job in a print queue for the printer, and wherein, in response to the printer status indicating that the printer is powered off, the total time period to print the print job further includes the time period to power on the printer. Still further, the computer program product includes computer usable program code for redirecting the print job from a default printer to a destination printer selected from the plurality of printers having a lower total time period to print the print job. Optionally, metadata about any other print jobs ahead of the print job in a print queue for the printer is obtained directly from the printer.

In the alternative embodiment, the computer usable program code for redirecting the print job from a default printer to a destination printer selected from the plurality of printers having a lower total time period to print the print job, may include computer usable program code for automatically selecting the destination printer, and computer usable program code for automatically redirecting the print job from the default printer to the destination printer. User settings or administrative tools may be used to establish that the destination printer should be automatically selected, as well as establish the criteria for automatically selecting the destination printer. For example, the criteria might prioritize printers that are physically closest to the default printer or provide the lowest total time period to print the print job.

In the alternative embodiment, the computer usable program code for redirecting the print job from a default printer to a destination printer selected from the plurality of printers having a lower total time period to print the print job, may also include or alternatively include computer usable program code for displaying one or more of the plurality of printers having a lower total time period to print the print job, and computer usable program code for receiving a user selection of the destination printer from the one or more displayed printers. This embodiment provides the user with a greater amount of context over the printer selection, but leaves the selection to the user.

A separate feature of the alternative embodiment includes computer usable program code for powering up another one of the plurality of printers in response to determining that the print job cannot be printed in less than a predetermined time period. The amount of predetermined time period is preferably set in the administrative tools.

Embodiments of the present invention may be widely implemented in networks having two or more printers. Individual users may submit print jobs, typically through a personal computer, notebook computer, tablet, or phone to a server that maintains the print manager application. The server may further include a print driver for each printer. The print manager application is able to communicate with each printer to determine its power status. Optionally, the print manager application is also able to communicate with each printer to quantify the print jobs currently in the printer's print queue.

The print manager application may also acquire printer profile data from the printer or a print driver. However, the print manager application stores in memory at least those portions of each printer profile that are not expected to change. For example, a printer manufacture may publish the values of a power on cost, rate of print cost, time period to power on, and print speed. Since these values are not expected to change appreciably over the life of the printer, the printer manage application will preferably acquire this data once and store it for future use. Any time that an additional printer is added to the network, an additional profile is created for the printer.

The embodiments of the present invention are particularly useful in a large business environment where the workload for printing can require a large number of printers on a typical day. However, during slow periods or weekends, a particular employee's default printer settings may not provide the best power consumption or time to completion for a print job since most default printers are selected only on the basis of the most convenient location for the employee. The printer manager applications of the present invention provide the employee with additional context to make an intelligent printer selection. For example, when a user goes to print a document, the print tools can either inform them of other printers that are already powered on (warmed up) or be configured ahead of time to direct the print job to a printer that is already ready to print.

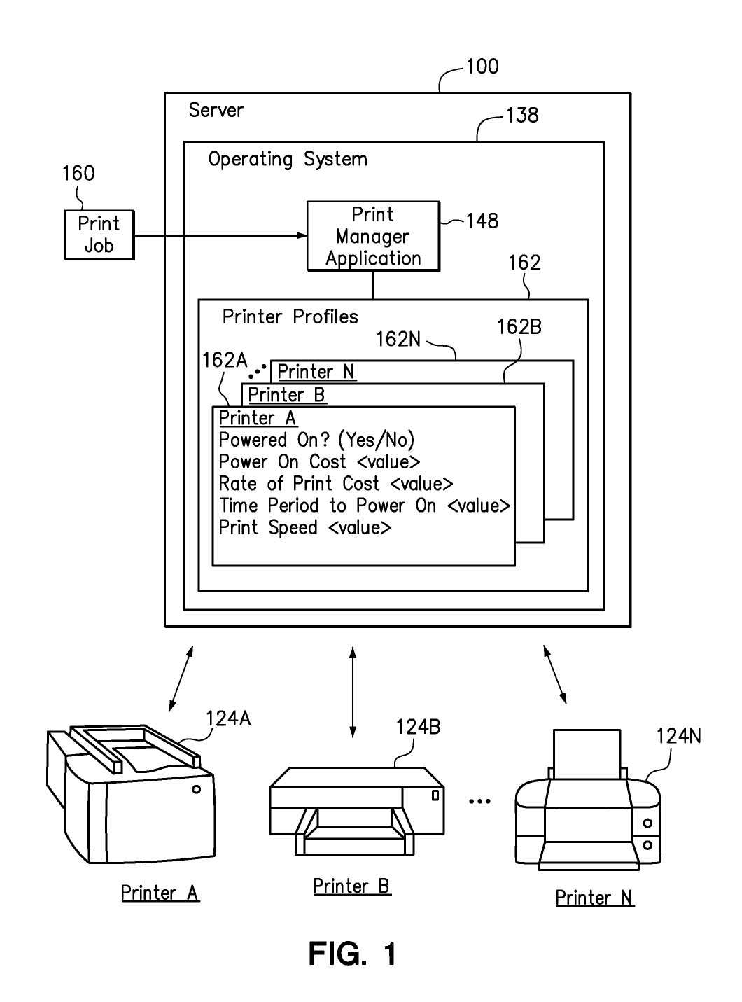

FIG. 1 is a diagram of a server 100 running an operating system (OS) 138 including a print manager application 148 for handling a print job 160 in accordance with one embodiment of the present invention. The print manager 148 receives the print job 160 from a computer or other network accessible device. Typically, the printer manger 148 will receive multiple print jobs from multiple computers. Each print job 160 will typically have a given job size, such as the number of pages to be printed, as well as identify a default printer to which the job may be assigned.

However, in accordance with embodiments of the present invention, the print manager application 148 maintains printer profiles 162A-162N that are each associated with one of the network printers 124A-124B. In the embodiment of FIG. 1, the printer profile 162A for “Printer A” 124A includes: (1) whether or not the printer is powered on, (2) the power on cost, (3) the rate of print cost, (4) the time period to power on, and (5) the print speed. The other printer profiles 162B-162N will include similar data that is specific to the associated printers 124B-124N.

According to one embodiment of the invention, the print job 160 may be directed to print on Printer A. However, if the printer manager application 148 may recognized that Printer A is powered off and determine that the total cost to print the print job would be lower if Printer B was used. Such a determination requires using the printer profile data for both Printer A and Printer B. Preferably, the print manager will determine, for each of the printers (A through N), a total cost to print using that printer. This data may be displayed to the user, for example in a print tool pop-up window, in order for the user to select a printer with this information available. Alternatively, the print manager may automatically redirect the print job from a default printer to a destination printer that has a lower total cost to print than does the default printer.

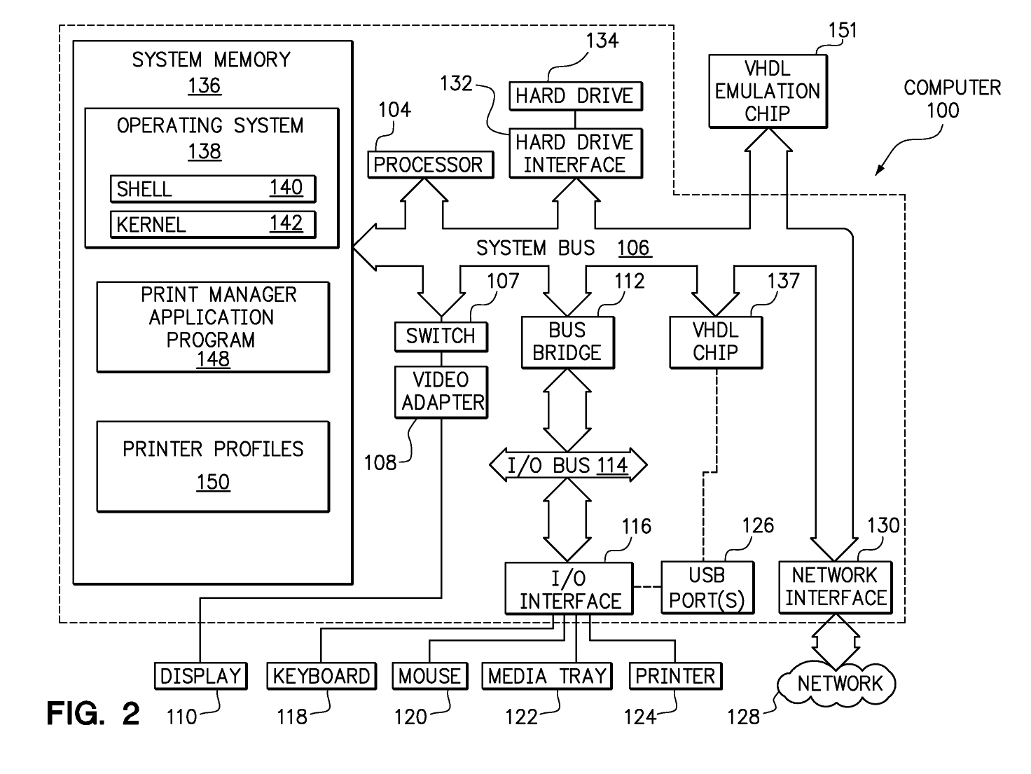

FIG. 2 is a diagram of a computer capable of running a print manager application in accordance with various embodiments of the present invention. Note that some or all of the exemplary architecture, including both depicted hardware and software, shown for and within the computer 100 may be implemented in the server 100 shown in FIG. 1.

Computer 100 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, the computer 100 is able to communicate over a network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 100. This volatile memory includes additional higher levels of volatile memory (not shown), including, but not limited to, cache memory, registers and buffers. Data that populates system memory 136 includes the computer's operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc. As depicted, the OS 138 also includes kernel 142, which includes lower levels of functionality for the OS 138, including providing essential services required by other parts of OS 138. Still further, the OS 138 includes a print manager application program 148, with access to printer profiles 150 stored in system memory 136 for use in accordance with embodiments of the invention described herein.

The system memory 136 may also include a VHDL (VHSIC hardware description language) program. VHDL is an exemplary design-entry language for field programmable gate arrays (FPGAs), application specific integrated circuits (ASICs), and other similar electronic devices. In one embodiment, execution of instructions from a VMPP causes a VHDL program to configure the VHDL chip 137, which may be an FPGA, ASIC, or the like.

In another embodiment of the present invention, execution of instructions from VMPP results in a utilization of VHDL program to program a VHDL emulation chip 151. VHDL emulation chip 151 may incorporate a similar architecture as described above for VHDL chip 137. Once VMPP and VHDL program the VHDL emulation chip 151, VHDL emulation chip 151 performs, as hardware, some or all functions described by one or more executions of some or all of the instructions found in VMPP. That is, the VHDL emulation chip 151 is a hardware emulation of some or all of the software instructions found in VMPP. In one embodiment, VHDL emulation chip 151 is a programmable read only memory (PROM) that, once burned in accordance with instructions from VMPP and VHDL program, is permanently transformed into a new circuitry that performs the functions needed to perform the processes of the present invention.

The hardware elements depicted in computer 100 are not intended to be exhaustive, but rather are representative devices suitable to perform the processes of the present invention. For instance, computer 100 may include alternate memory storage devices such as magnetic cassettes, digital versatile disks (DVDs), Bernoulli cartridges, and the like. These and other variations are intended to be within the spirit and scope of the present invention.

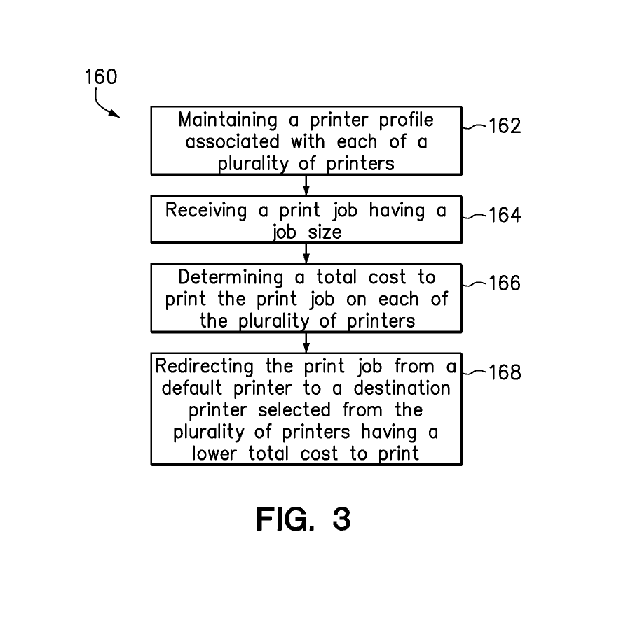

FIG. 3 is a flowchart of a method 160 of handling print jobs based upon the total cost to print the print job. It should be recognized that the method may be implement by a computer program product including computer usable program code embodied on a tangible computer usable storage medium for handling a print job. In step 162, a printer profile is maintained in associated with each of a plurality of printers. In one option, each printer profile includes the current power status of the associated printer, a cost to power up the associated printer, and a rate of cost to print. In step 164, a print job having a job size is received and, in step 166, a total cost to print the print job is determined for each of the plurality of printers. Optionally, the total cost to print the print job may include the mathematical product of the rate of cost to print and the job size. If the printer status indicates that the printer is powered off, then the total cost further includes the cost to power on the printer. Then, in step 168, the print job is redirected from a default printer to a destination printer selected from the plurality of printers having a lower total cost to print.

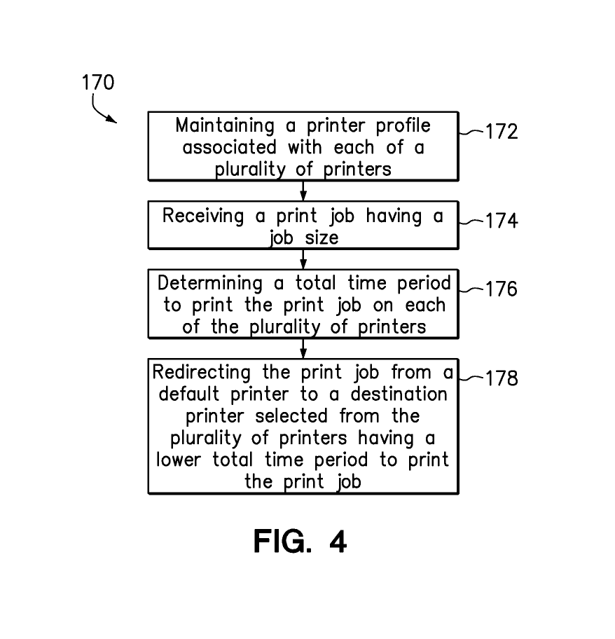

FIG. 4 is a flowchart of a method 170 of handling print jobs based upon the total time period to print the print job. Again, it should be recognized that the method may be implement by a computer program product including computer usable program code embodied on a tangible computer usable storage medium for handling a print job. In step 162, the method maintains a printer profile associated with each of a plurality of printers. Optionally, each printer profile includes the current power status of the associated printer, a time period to power up the associated printer, and a print speed. A print job having a job size is received in step 164, and a total time period to print the print job is determined for each of the plurality of printers in step 166. Optionally, the total time period to print the print job includes the quotient of the job size divided by the print speed, plus an amount of time necessary to complete any other print jobs ahead of the print job in a print queue for the printer. Furthermore, if the printer status indicates that the printer is presently powered off, then the total time period to print the print job further includes the time period to power on the printer. Then, in step 168, the print job is redirected from a default printer to a destination printer selected from the plurality of printers having a lower total time period to print the print job.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product including computer usable program code embodied on a tangible computer usable storage medium, the computer program product comprising:
computer usable program code for maintaining a printer profile associated with each of a plurality of printers, wherein each printer profile includes the current power status of the associated printer, a cost to power up the associated printer, and a rate of cost to print;
computer usable program code for receiving a print job having a job size;
computer usable program code for determining a total cost to print the print job on each of the plurality of printers, wherein the total cost to print includes the mathematical product of the rate of cost to print and the job size, and wherein, in response to the printer status indicating that the printer is powered off, the total cost further includes the cost to power on the printer; and
computer usable program code for redirecting the print job from a default printer to a destination printer selected from the plurality of printers having a lower total cost to print.

2. The computer program product of claim 1, wherein the computer usable program code for redirecting the print job from a default printer to a destination printer selected from the plurality of printers having a lower total cost to print, includes:
computer usable program code for automatically selecting the destination printer; and
computer usable program code for automatically redirecting the print job from the default printer to the destination printer.

3. The computer program product of claim 1, wherein the cost is expressed in an amount of power or currency.

4. The computer program product of claim 1, wherein the rate of cost to print is an amount of cost per page, and wherein the job size includes a total number of pages.

5. The computer program product of claim 1, wherein the computer usable program code for redirecting the print job from a default printer to a destination printer selected from the plurality of printers having a lower total cost to print, includes:
computer usable program code for displaying one or more of the plurality of printers having a lower total cost to print; and
computer usable program code for receiving a user selection of the destination printer from the one or more displayed printers.

6. The computer program product of claim 1, wherein the plurality of printers are network printers.

7. A computer program product including computer usable program code embodied on a tangible computer usable storage medium, the computer program product comprising:
computer usable program code for maintaining a printer profile associated with each of a plurality of printers, wherein each printer profile includes the current power status of the associated printer, a time period to power up the associated printer, and a print speed;
computer usable program code for receiving a print job having a job size;
computer usable program code for determining a total time period to print the print job on each of the plurality of printers, wherein the total time period to print the print job includes the quotient of the job size divided by the print speed, wherein the total time period to print the print job further includes an amount of time necessary to complete any other print jobs ahead of the print job in a print queue for the printer, and wherein, in response to the printer status indicating that the printer is powered off, the total time period to print the print job further includes the time period to power on the printer; and
computer usable program code for redirecting the print job from a default printer to a destination printer selected from the plurality of printers having a lower total time period to print the print job.

8. The computer program product of claim 7, wherein the computer usable program code for redirecting the print job from a default printer to a destination printer selected from the plurality of printers having a lower total time period to print the print job, includes:
computer usable program code for automatically selecting the destination printer; and
computer usable program code for automatically redirecting the print job from the default printer to the destination printer.

9. The computer program product of claim 7, wherein the computer usable program code for redirecting the print job from a default printer to a destination printer selected from the plurality of printers having a lower total cost to print, includes:
computer usable program code for displaying one or more of the plurality of printers having a lower total time period to print the print job; and
computer usable program code for receiving a user selection of the destination printer from the one or more displayed printers.

10. The computer program product of claim 7, wherein the plurality of printers are network printers.

11. The computer program product of claim 7, further comprising:
computer usable program code for powering up another one of the plurality of printers in response to determining that the print job cannot be printed in less than a predetermined time period.
